(19) United States
(12) Patent Application Publication
(10) Pub. No.: US 2006/0207828 A1
(43) Pub. Date: Sep. 21, 2006

(54) Safety harness

(76) Inventor: Andrae T. D'Acquisto, Milwaukee, WI (US)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(21) Appl. No.: 11/357,526

(22) Filed: Feb. 17, 2006

Related U.S. Application Data
(60) Provisional application No. 60/654,428, filed on Feb. 18, 2005.

(51) Int. Cl. A62B 35/00

(52) U.S. Cl. 182/3

(57) ABSTRACT

The present invention is an improved safety harness for use by individuals in elevated positions. The harness has a highly simplified construction in which a pair of straps is connected to an adjustable waist belt and extends around the body of an individual to form shoulder portions and leg portions for the harness. The leg portions are secured at one end to the waist belt and include a releasable clasp at the opposite end that is engageable with the waist belt to releasably secure the harness to an individual. The harness also includes a safety line engageable with the harness and with a support holding the individual in an elevated position, where the harness includes a shock absorbing and sliding mechanism capable of gradually stopping or arresting the fall of the individual while also allowing the individual to manually lower the individual to the ground along the safety line.

### CROSS-REFERENCE TO RELATED APPLICATION

This application claims the benefit of U.S. Provisional Patent Application Serial No. 60/654,428, filed on Feb. 18, 2005, and incorporated by reference herein in its entirety.

### FIELD OF THE INVENTION

The present invention relates to safety devices and, more specifically, to a safety harness and descending mechanism for use by an individual when positioned above the ground.

### BACKGROUND OF THE INVENTION

In order to prevent individuals from falling from elevated platforms, such as tree stands, a number of different types of safety devices have been developed. One particularly useful type of safety device is a harness that is attachable to the tree, pole or other support on which the individual is standing. If the individual happens to fall off of the platform, the harness, because it is attached to the support, operates to stop the fall of the individual after a short distance in order to prevent the individual from striking the ground.

However, while many prior art harnesses are capable of stopping the fall of the individual, these harnesses have drawbacks, which can prevent an individual from using the harness as the safety device for which it is intended. For example, many harnesses have a very complicated construction with many separate interlocking and releasably engaged parts that make the harness highly difficult to assemble and put on. Due to this difficulty, many individuals do not utilize the harness at all.

Further, various prior art harness structures, while capable of stopping the fall of an individual, do not provide any mechanism to enable the individual to raise themselves back onto the platform or to lower themselves to the ground in a controlled manner after the safety harness has been engaged. Therefore, these prior art harnesses leave the individual in a suspended position without the ability to easily climb back on to the platform or lower themselves to the ground.

Additionally, when many prior art harnesses engage to stop the fall of an individual, the harness exerts an instantaneous and significant force on the body of the individual in a direction directly opposite to the direction in which the individual is falling. The magnitude of this force can often cause injury to the individual depending upon both the size of the individual and the length of the fall traveled by the individual, i.e., the momentum of the individual, before the engagement of the harness.

Therefore, it is desirable to develop a safety harness for use by an individual in a suspended position which is simple to assemble and use, that provides the individual with a descending mechanism that can be utilized to lower the individual to the ground, and which also provides an amount of shock absorption when stopping the fall of an individual.

### SUMMARY OF THE INVENTION

According to a primary aspect of the present invention, a safety harness is provided that includes a minimum of adjustable and/or releasable portions in order to greatly reduce the complexity of the construction of the harness and increase its ease of use. Specifically, the harness is formed with a pair of straps connected to a waist strap or belt to form a pair of shoulder-engaging strap portions. The pair of straps also extend past the waist belt to form a pair of leg-engaging strap portions extending from the waist strap opposite the shoulder-engaging strap portions. Each of these leg-engaging portions include a simple clasp at one end that is releasably engageable with the waist strap to quickly and easily secure the harness on an individual. The clasp has a very simple construction that is easily engageable and disengageable from the waist strap allowing the individual to easily put on and take off the harness as desired. Furthermore, the harness is adjustable along the waist strap and along each of the leg straps in order to enable the harness to more adequately accommodate the particular individual utilizing the harness, while the remainder of the pieces of the harness are fixed in length to reduce the complexity of the harness.

According to another aspect of the present invention, a harness includes a safety strap that is attached to the rear of the harness at one end and is engageable with a safety line at the opposite end. The safety line is secured opposite the safety strap around the support holding the individual in the elevated position, and includes a releasably lockable securing mechanism engaged with the safety strap. The securing mechanism is also engaged with a descent or sliding mechanism which functions to stop the fall of the individual with some amount of shock absorption, while also enabling the individual to manually perform a controlled descent along the safety line to the ground.

According to still another aspect of the present invention, the reduced complexity of the safety harness enables the harness and safety line to be manufactured more easily and at a much-reduced cost from prior art harnesses.

Numerous other aspects, features and advantages of the present invention will be made apparent from the following detailed description taken together with the drawing figures.

### BRIEF DESCRIPTION OF THE DRAWINGS

The drawings illustrate the best mode currently contemplated as practicing the present invention.

In the drawings:

FIG. 1 is a front view of the safety harness of the present invention;

FIG. 2 is a rear view of the safety harness of FIG. 1;

FIG. 3 is partially broken away isometric view of a descending mechanism and a sliding member attached to the safety harness of FIG. 1;

FIG. 4A is a partially broken away perspective view of a securing clasp disposed on the safety harness of FIG. 1;

FIG. 4B is a partially broken away perspective view of the securing clasp of FIG. 4A engaged with the safety harness of FIG. 1; and

FIG. 5 is an isometric view of the descending mechanism engaged with the safety harness of FIG. 1.

### DETAILED DESCRIPTION OF THE INVENTION

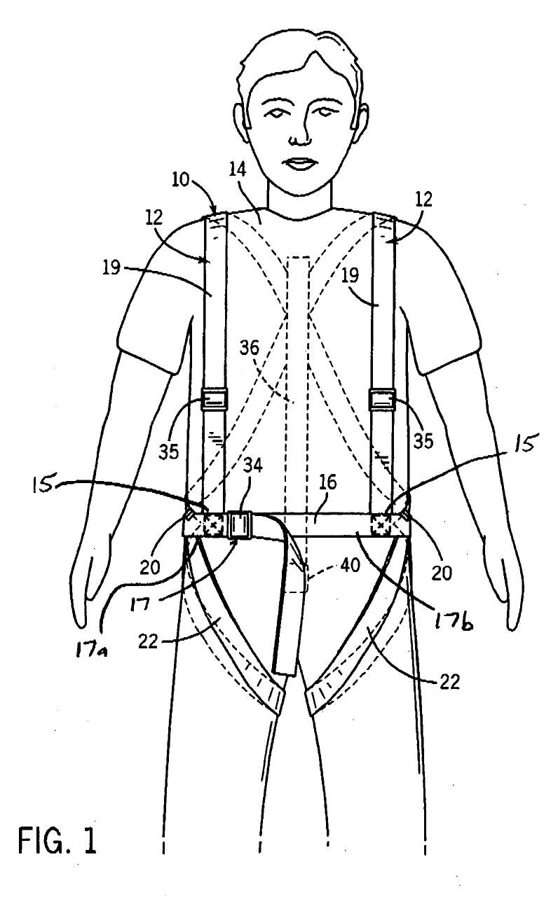

With reference now to the drawing figures in which like reference numerals designate like parts throughout the disclosure, a safety harness constructed according to the present invention is indicated generally at 10 in FIG. 1. As best shown in FIGS. 1, 2, and 4A-5, the harness 10 includes a pair of straps 12 positioned on opposite sides of the body of an individual 14 and each engaged at one end 15 with a waist strap or belt 16. The waist strap 16 is formed of a loop of a suitable material, such as nylon or canvas, among others, and that can include a separable closure 17 that operates to secured opposed front halves 17a and 17b to one another to form the enclosed waist strap 16 in conjunction with rear section 17c. Each strap 12 extends from the waist strap 16 over the shoulder of the individual to the back of the individual, where the straps 12 cross at a location 18 approximately adjacent the middle of the individual's back forming a pair of shoulder engaging portions 19. The engagement of the straps 12 at the location 18 prevents the straps 12 from shifting with regard to one another while being worn by an individual 14, thereby keeping the shoulder engaging portions of the straps 12 disposed securely on the individual 14. The straps 12 extend downwardly from the location 18 and are again secured to the waist strap 16 at locations 20 approximately adjacent each side of the waist of the individual 14.

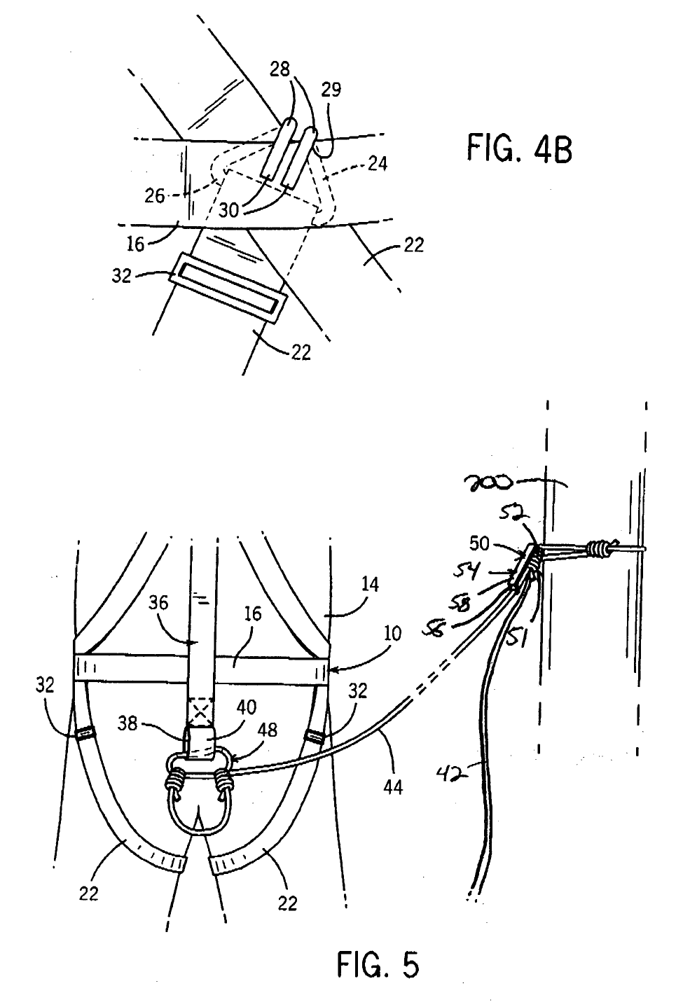

The straps 12 continue downwardly from the locations 20 on the waist strap 16 to form a pair of leg engaging strap portions 22 that are releasably positionable around the legs of the individual 14 to secure the individual 14 within the safety harness 10 in conjunction with the shoulder engaging portions 19. Each of the leg portions 22 includes a safety clasp 24 located opposite the waist strap 16 that is releasably engageable with the waist strap 16, as best shown in FIGS. 4A-4B. The clasp 24 is formed of a rigid piece of material such as a metal or hard plastic material, and preferably a piece of iron or steel, that forms a strap receiving portion 26 and a pair of strap-engaging portions 28 that extend outwardly from the strap receiving portion 26 and define a channel 29 therebetween. The channel 29 is dimensioned such the leg portions 22 can be inserted through the channel 29 and engaged within the receiving portion 26 while also preventing the inadvertent disengagement of the leg strap 22 from the receiving portion 26. In a particularly preferred embodiment, the strap-receiving portion 26 receives a looped end 100 of the leg strap 22 that defines an opening 102 therein in order to securely hold the leg strap 22 in engagement with the clasp 24. To secure the looped end 100 to the clasp 24, one of the engaging portions 28 is inserted through the opening 102 until the entire looped end 100 passes over the engaging portion 28 and onto the receiving portion 26. The receiving portion 26 preferably has a length slightly longer than the width of the looped end 100, such that the looped end 100 can sit squarely over the receiving portion 26, with any forces from the leg strap 22 being exerted on the looped end 100 and the receiving portion 26 in a direction opposite the engaging portions 28 and channel 29, which maintains the strap 22 engaged with the clasp 24.

The engaging portions 28 of the clasp 24 are each formed with a hook 30 at an outer end that can securely engage the clasp 24 and leg strap 22 with the waist strap 16 to secure the harness 10 on the individual 14 in one of two configurations. In a first configuration, the engaging portions 28 and hooks 30 can be positioned to extend from the leg strap 22 between the individual 14 in order to engage the hooks 30 with the waist strap 16 immediately adjacent the locations 20 from which the leg portions 22 extend. In this configuration, the weight of the individual 14 within the safety harness 10 presses downwardly on the leg portions 22 of the straps 12, thereby pulling the hooks 30 of the clasp 24 downwardly into secure engagement with the waist strap 16. Also, the engagement of the hooks 30 at the location 20 defined by the engagement of the straps 12 with the waist strap 16 provides a barrier to prevent the movement of the hooks 30 along the waist strap 16, thereby ensuring that the leg straps 22 remain in proper securing position with regard to the remainder of the harness 10. Alternatively, the clasp 24 can be positioned between the waist strap 16 and the individual 14 with the hooks 30 of the engaging portions extending downwardly over the exterior of the waist strap 16 in a reversed configuration from the first configuration. In this configuration, because the clasp 24 is positioned between the waist strap 16 and the individual 14, the weight of the individual 14 wearing the harness 10 presses the clasp 24 against the waist strap 16 to provide an additional securing force to hold the hooks 30 of the engaging portions 28 of the waist strap 16. In addition, because the clasps 24 are located inside of the waist strap 16 in this configuration, the potential for inadvertently striking and disengaging the clasps 24 from the waist strap 16 is significantly reduced.

In order to enable the leg portions 22 to be adjusted to accommodate individuals of varying sizes, the leg portions 22 each include a buckle 32 that allows the overall length of the leg portions 22 to be varied as necessary in a known manner. Further, the overall length of the waist strap 16 can also be varied in a known manner through the use of a buckle 34 positioned on one end of the waist strap 16 and releasably engageable with the opposite end of the waist strap 16. Optionally, the shoulder portions 19 can also include buckles 35 to allow for the adjustment of the length of the shoulder portions 19.

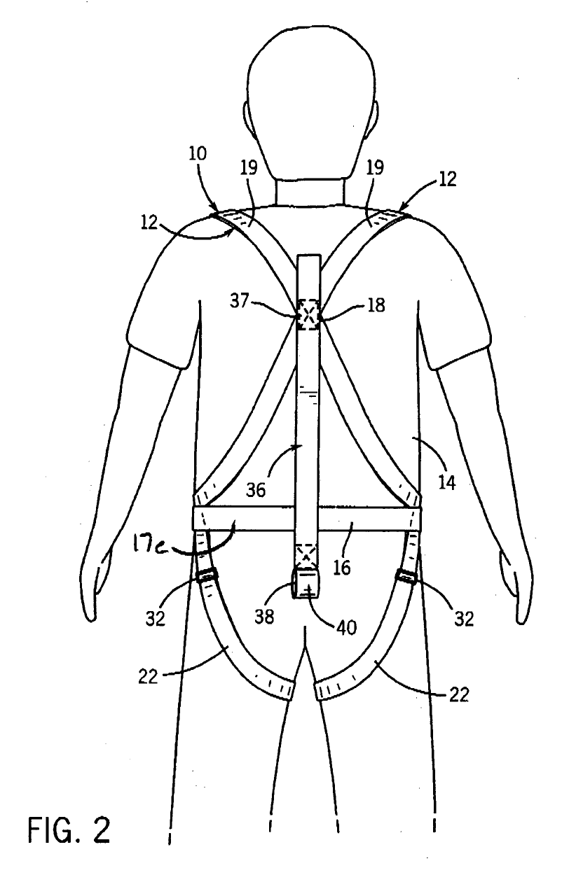

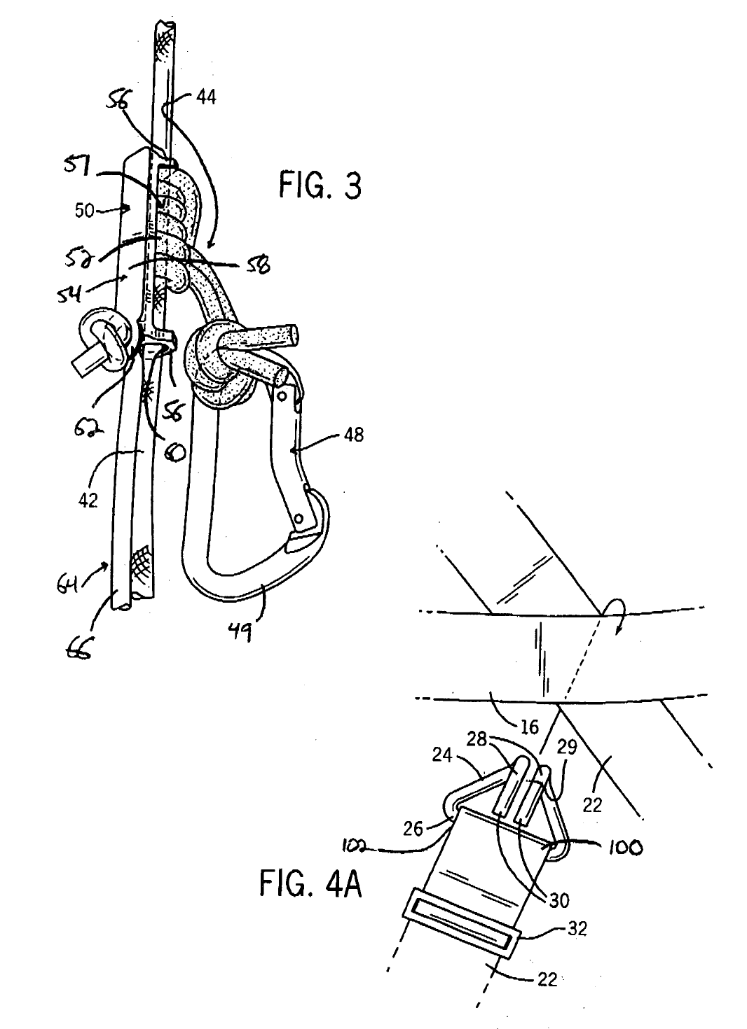

At the location 18 where in the straps 12 are joined to one another, the harness 10 also includes a safety strap 36 that is secured at one end 37 to the straps 12 at the location 18 and has a second end 38 that extends outwardly from the straps 12. The second end 38 has a loop 40 formed thereon that is engageable with a safety line 42, best shown in FIGS. 2, 3 and 5. The safety line 42 includes a securing line 44 and is attachable to the support 200 on which the individual 14 is supported at one end and to the loop 40 on the safety strap 36 at the opposite end. The end of the safety line 42 engaged with the support 200 can be engaged in any suitable manner, but is preferably engaged simply by forming a loop 46 in the safety line 42 and positioning the loop 46 around the support 200 such that the loop 46 will not slide along the support 200 when the safety harness 10 is in use. The end of the safety line 42 opposite the support 200 simply hangs down from the support 200 to a short distance above the ground, e.g., no more than three (3) feet.

The securing line 44 includes a securing mechanism 48 at one end capable of securely engaging the loop 40 on the safety strap 36. The mechanism 48 is preferably a carabiner 49 that allows for easily engagement and disengagement of the securing line 44 from the safety strap 36 of the safety harness 10.

Opposite the mechanism 48, is the securing line 44 engaged with the safety line 42 by a descending or sliding mechanism 50. The descending mechanism 50 is engaged with the safety line 42 between the opposed ends of the line 42 in order to function as a fall arrester in conjunction with the securing line 44, and as a manually operable lowering mechanism to enable an individual 14 held in an elevated position on the safety line 42 by the harness 10 and the securing line 44 to use the descending mechanism 50 to lower the harness 10 and the individual 14 along the safety line 42 to the ground. The descending mechanism 50 can be any suitable and manually operable mechanism. In a particularly preferred embodiment, the descending mechanism 50 is formed with a sliding member 51, such as a Prusik knot, formed on the securing line 44 using a length of a securing cord 52. However, the sliding member 51 may also be formed using only the end of the securing line 44 opposite the carabiner 49.

The descending mechanism 50 is attached to the safety line 42 adjacent the securing line 44 such that, when the securing line 44 is employed to hold the safety harness 10 and individual 14 in an elevated position, the descending mechanism 50 can be utilized to engage the securing line 44 in a manner that allows the securing line 44, sliding member 51 and securing mechanism 48 to slide along the safety line 42 and to lower the individual 14 in a controlled manner. Additionally, because the descending mechanism 50 operates to selectively disengage the securing line 44 from the safety line 42, thereby allowing the securing line 44 to slide along the safety line 42, if the descending mechanism 50 is not operable for some reason, the harness 10 and individual 14 are still secured to the safety line 42 by the securing line 44 and securing mechanism 48, such that the individual 14 will not become suddenly and unexpectedly disengaged from the safety line 42. Additionally, the securing mechanism 48 can be secured to the free end of the safety line 42 opposite the support 200 to further ensure that the harness 10 and individual 14 are maintained in connection with the safety line 42

In order to manually operate the descending mechanism 50, an operating member 54 is connected to the safety line 42 on opposite sides of the descending mechanism 50. The operating member 54 includes a pair of loop structures 56 disposed at each end of a base 58. The loop structures 56 each define a central opening 60 therein through which the safety line 42 can be threaded, and are spaced from one another by the base 58 a distance sufficient to allow the securing line 44 to be positioned around the safety line 42 between the structures 56. The base 58 also includes a tab 62 extending from a lower end thereof generally perpendicular to the structures 56, and to which can be attached a handle 64. The handle 64 preferably takes the form of a length of rope 66 that can be secured to the tab 62 and can extend downward from the tab 62 a sufficient distance to allow an individual 14 held on the safety line 42 by the securing line 44 and the descending mechanism 50 to easily grasp the rope 66.

In operation, when an individual 14 slips off of a support 200 or platform, the weight of the individual 14 exerts a force on the harness 10 that is transmitted through the safety strap 36 and the securing mechanism 48 to the securing line 44. This force transmitted to the securing line 44 pulls the line 44 into engagement with the safety line 42 to prevent the securing line 44 and sliding member 51 from moving along the safety line 42. In particular, the sliding member 51 pulls on the safety line 42 to shift the section of the safety line 42 engaged with the sliding member 51 away from the vertical. This frictionally locks the sliding member 51 and securing line 44 in position on the safety line 42 to stop the sliding member 51 and line 44 from sliding along the safety line 42. In the process of engaging safety line 42, the sliding member 51 can also slide a relatively short distance along the safety line 42 in order to provide a somewhat gradual increasing level of resistance to the movement of the harness 10 and the individual 14 along the safety line 42 prior to completely stopping the fall of the individual 14, thus providing an amount of shock resistance.

Once the sliding member 51 has stopped the initial fall of the individual 14, the individual 14 can grasp the rope 66 secured to the operating member 54 and pull downwardly on the rope 66. The force exerted on the rope 66 is transmitted to the base 58, and operates to pull the base 58 and loop structures 56, in conjunction with the section of safety line 42 disposed between the loop structures 56 on the base 58, into a generally vertical position. This reduces the frictional engagement of the sliding member 51 with the safety line 42 such that the sliding member 51 can slide along the safety line 42 as long as the force exerted on the base 58 via the rope 66 is sufficient to pull the safety line 42 and the sliding member 51 into a generally vertical position. If the force exerted by the individual 14 on the rope 66 is released, the sliding member 51 will re-engage the safety line 42 and prevent any further downward movement of the sliding member 51, harness 10, and individual 14 along the safety line 42. In this manner, an individual 14 can control the descent of the individual 14 along the safety line 42 to a position in contact with or immediately above the ground.

In order to provide additional shock absorption to the individual 14 utilizing the harness 10, the safety line 42 is preferably formed from an eight (8) mm static rope manufactured by Sterling Rope Company, while the securing line 44, and optionally the sliding member 51 when integrally formed with the securing line 44, is preferably formed from a six (6) mm static rope manufactured by Sterling Rope Company. The use of the diameter ropes specified enables the sliding member 51 to move a short distance along the safety line 42 when an individual 14 utilizing the harness 10 initially falls with respect to the support 200, thereby providing shock absorption to the individual 14 between freefall and a complete arrest of the freefall, instead of a sudden and complete jerking stop, as with prior art harnesses. Also, the diameter specified for the safety line 42 and securing line 44 enables the descending mechanism 50 to operate more smoothly when lowering the individual 14 within the harness 10.

Various alternatives are contemplated as being within the scope of the following claims particularly pointing out and distinctly claiming the subject matter regarded as the invention.

What is claimed is:

1. A safety apparatus comprising:
a) a body engaging harness including a waist belt engageable to an individual and a pair of support straps each fixedly engaged to the waist belt at one end and releasably engaged to the waist belt at the opposite end;
b) a safety line releasably secured to the body engaging harness at one end and engageable with a support at the opposite end; and
c) a descending mechanism operably connectable to the safety line.

2. The safety apparatus of claim 1 wherein the waist belt includes a front portion and a rear portion, and wherein the front portion includes a pair of opposed halves joined by a separable enclosure.

3. The safety apparatus of claim 2 wherein each of the pair of support straps is secured at a first end to each of the halves of the front portion of the waist belt.

4. The safety apparatus of claim 3 wherein each of the pair of support straps is secured to the rear portion of the waist belt between the first end and a second end to form a shoulder-engaging portion for each of the pair of support straps.

5. The safety apparatus of claim 1 further comprising a securing hook disposed on the second end of each of the pairs of straps.

6. The safety apparatus of claim 5 wherein the securing hook includes a support strap holding portion and a waist strap-engaging portion.

7. The safety apparatus of claim 6 wherein the waist strap-engaging portion includes a pair of prongs that define a channel therebetween.

8. The safety apparatus of claim 7 wherein the support strap holding portion extends between the pair of prongs and defines a strap holding opening therein.

9. The safety apparatus of claim 1 wherein the safety line includes a vertically extending member and a sliding member adjustably mounted to the vertically extending member and engageable with the body-engaging harness.

10. The safety apparatus of claim 9 wherein the descending mechanism comprises a descending line secured to the vertically extending member adjacent the sliding member.

11. The safety apparatus of claim 10 wherein the descending line is positioned on the vertically extending member immediately adjacent the sliding member.

12. The safety apparatus of claim 11 wherein the sliding member is a Prusik knot.

13. A body-engaging harness comprising:
a) a waist belt engageable on an individual and including a front portion and a rear portion, wherein the front portion includes a pair of opposed halves selectively joined by a separable closure;
b) a pair of support straps each fixedly engaged to the waist belt at a first end and releasably engaged to the waist belt at a second end; and
c) a pair of securing hooks disposed on each of the pair of support straps opposite the waist belt.

14. The body-engaging harness of claim 13 wherein each of the pair of support straps is secured at the first end to each of the halves of the front portion of the waist belt.

15. The body-engaging harness of claim 14 wherein the pair of support straps is secured to the rear portion of the waist belt between the first end and the second end to form a shoulder-engaging portion on each support strap.

16. A method for arresting the fall of an individual, the method comprising the steps of:
a) providing a safety apparatus comprising a body-engaging harness including a waist belt engageable to an individual, and a pair of support straps each fixedly engaged to the waist belt at a first end and releasably engaged to the waist belt at the second end, a safety line releasably secured to the body-engaging harness at one end and engageable with the support at the opposite end, and a descending mechanism operably connected to the safety line;
b) securing the body-engaging harness to the individual;
c) engaging the safety line to the support;
d) connecting the descending member to the safety line; and
e) lowering the individual along the safety line with the descending member.

17. The method of claim 16 wherein each of the pair of support straps includes a securing hook located at the second end and wherein the step of securing the body-engaging portion to the individual comprises the steps of:
a) placing the waist belt and support straps on the individual; and
b) engaging the hooks with the waist belt.

18. The method of claim 16 wherein the safety line includes a vertically extending member and a sliding member disposed on the vertically extending member, and wherein the step of lowering the individual along the safety line comprises moving the sliding member along the safety line with the descending mechanism.

19. The method of claim 18 further comprising a descending member operably connected to the vertically extending member adjacent the sliding member, and wherein the step of moving the sliding member comprises engaging the descending member with the sliding member to move the sliding member along the vertically extending line.

20. The method of claim 19 wherein the descending member comprises a rigid base secured to the vertically extending line and a handle connected to the base, and wherein the step of engaging the descending member with the sliding member comprises pulling the rope to engage the base with the sliding member.
